(19) United States
(12) Patent Application Publication
(10) Pub. No.: US 2008/0083800 A1
(43) Pub. Date: Apr. 10, 2008

(54) ROOF RAILING ASSEMBLY

(75) Inventor: Boney A. Mathew, Clarkston, MI (US)

Correspondence Address: DICKINSON WRIGHT PLLC, 38525 WOODWARD AVENUE, SUITE 2000, BLOOMFIELD HILLS, MI, 48304-2970, US

(73) Assignee: MATHSON INDUSTRIES, Troy, MI (US)

(21) Appl. No.: 11/869,109

(22) Filed: Oct. 9, 2007

Related U.S. Application Data
(60) Provisional application No. 60/850,555, filed on Oct. 10, 2006.

(51) Int. Cl. B60R 9/048

(52) U.S. Cl. 224/326; 224/309; 224/322

(57) ABSTRACT

A roof railing assembly (20) includes a rail (22), a bracket attachment (28) disposed on the rail (22), and a fastener (44, 46, 48) on the bracket attachment (28), wherein the bracket attachment (28) is a defined by a structural layer of material (40) which defines a plurality of small voids (42). A flange (54) is disposed about the fastener (44, 46, 48) for restricting axial movement. An insulating layer (56) is disposed about the supported end (50) of the fastener (44, 46, 48) for absorbing force. The outer diameter of the flange (54) is greater than the outer diameter of the insulating layer (56) to further restrict axial movement. A torque limiter (58) is disposed about the fastener (44, 46, 48) for disconnecting the fastener (44, 46, 48) from the vehicle roof to avoid excessive loading on the fastener (44, 46, 48). A plurality of ribs (60) are disposed on the fastener (44, 46, 48) and extend radially outwardly into the bracket attachment (28) for restricting rotational movement of the fastener (44, 46, 48).

### CROSS-REFERENCE TO RELATED APPLICATIONS

This application claims priority to Provisional Application 60/850,555, for BMW E70 ROOF RAILING ASSEMBLY, filed on Oct. 10, 2006.

### BACKGROUND OF THE INVENTION

1. Field of the Invention

A roof railing assembly for a vehicle roof of a vehicle.

2. Description of the Prior Art

Roof railing assemblies for motor vehicles typically include a rail having bracket attachments for supporting the rail on the vehicle roof with a fastener on each bracket attachment for securing the assembly to the roof.

Examples of roof railing assemblies are disclosed in U.S. Pat. No. 5,497,924 to Fisch et al., U.S. Pat. No. 5,573,159 to Fisch et al., and U.S. Pat. No. 5,893,499 to Lumpe et al.

The '924 patent discloses a bracket having a fastener disposed at one end for fastening the assembly to the vehicle roof and a rail attachment disposed at the other end for attaching the bracket to the rail. The fastener and rail attachment are connected to one another with a metal plate wherein the bracket is molded about the plate, fastener and rail attachment. Accordingly, the bracket is a solid structure.

The '159 patent teaches a rail assembly having a hollow metal rail having two opposite ends wherein the top surface and the bottom surface of the rail converge at each end to form an integral bracket attachment. A fastener secures the assembly to the vehicle roof at the location where the surfaces converge. A cover is disposed over the bracket attachment for improving the appearance of the assembly by concealing the fastener.

The '499 patent discloses a rail having a bracket attachment secured to the underside of each end thereof. The top surface of each bracket attachment is concave to follow the shape of the underside of the rail ends. The bracket attachments are solid structures and include fasteners to secure the assembly to the roof of a vehicle.

Typically, the bracket attachments are metal to provide the necessary structural rigidity. However, metal is highly corrosive, dense, and requires many parts. Plastic may be used; however, due to its high coefficient of thermal expansion, injection molded plastic parts warp as they cool. In addition, the coefficient of thermal expansion of plastic is much higher compared to that of the coefficient of thermal expansion of metals and their alloys. Therefore, plastic parts connected to metal parts develop sink marks and cracks due to the large difference between the coefficients of thermal expansion of each part, particularly in automotive applications where the parts are exposed to extreme temperatures. Furthermore, plastic is less rigid than metal and therefore provides less structural support.

Although the prior art rail assemblies provide adequate support and rigidity on a vehicle roof, there remains a need for a light-weight rail assembly having smooth, non-warped surfaces while providing the necessary structural rigidity.

### SUMMARY OF THE INVENTION AND ADVANTAGES

The invention provides a roof railing assembly including a rail, a bracket attachment disposed on the rail, and a fastener on the bracket attachment for securing the assembly to the roof of a vehicle, wherein the bracket attachment is defined by a structural layer of material disposed about the fastener. A surface layer is disposed about the structural layer of material of the bracket attachment for providing a smooth outer surface

The invention also provides a roof railing assembly including a torque limited disposed about the fastener for disconnecting the fastener from the vehicle roof to avoid excessive loading on the fastener.

The invention also provides a roof railing assembly wherein the fastener extends along an axis and a plurality of ribs are disposed on the fastener extending radially outwardly from the axis. The ribs extend into the bracket attachment for restricting rotational movement of the fastener relative to the bracket attachment.

The invention provides an assembly having structural rigidity, dimensional stability, and outer surface quality similar to rail assemblies having metal bracket attachments, while simultaneously providing a weight reduction. Additionally, the number of parts and manufacturing steps are reduced thus decreasing the total manufacturing cost of the rail assembly. Furthermore, corrosion resistance of the rail assembly is improved and the life of tooling required to manufacture the assembly is increased.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of the preferred embodiment of the rail assembly;

FIG. 2 is a fragmentary perspective exploded view of the embodiment shown in FIG. 1 illustrating a front bracket attachment;

FIG. 2a is a front of the embodiment shown in FIG. 2 taken at the line 3-3;

FIG. 3 is a fragmentary cross-sectional view of the embodiment shown in FIG. 2; and

FIG. 4 is a fragmentary cross-sectional view of the embodiment shown in FIG. 1 taken at line 4-4 illustrating a center bracket attachment.

### DETAILED DESCRIPTION OF THE INVENTION

Referring to the Figures, wherein like numerals indicate corresponding parts throughout the several views, a roof railing assembly 20 for a vehicle roof (not shown) of a vehicle is generally shown.

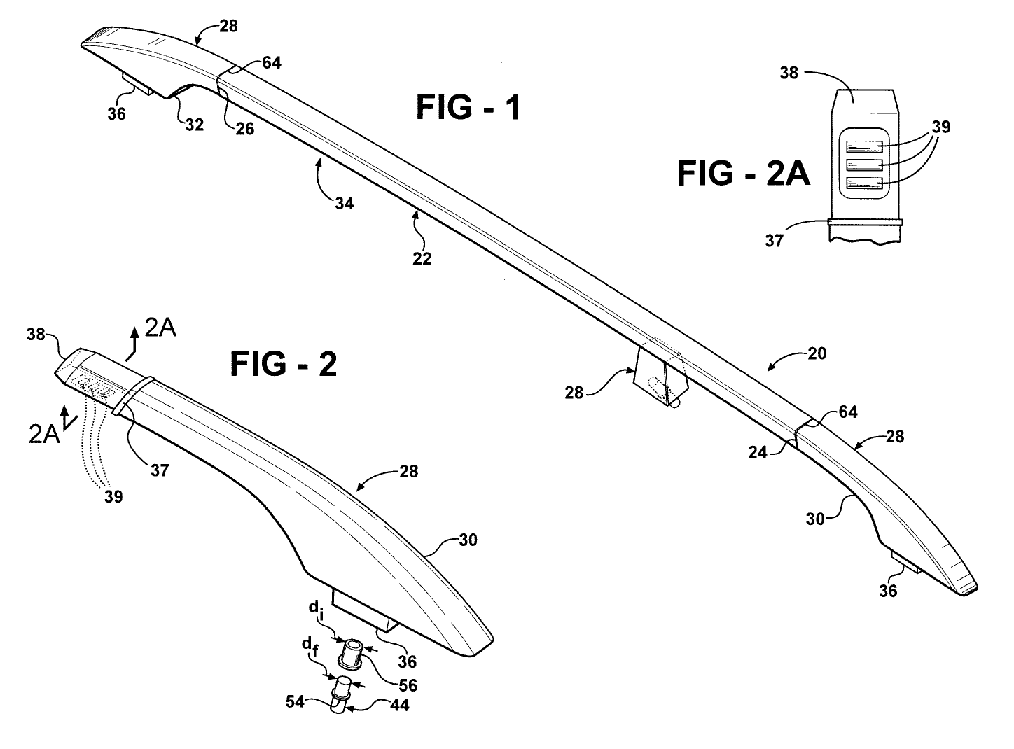

A rail 22 is generally indicated in FIG. 1 and has a front end 24 and a rear end 26. The rail 22 is generally tubular and extends parallel to the vehicle roof. A bracket attachment 28 is generally shown and is disposed on the rail 22 for supporting the rail 22 on the vehicle roof. The bracket attachment 28 includes a front bracket attachment 30 disposed on the rail 22, a rear bracket attachment 32 disposed on the rail 22, and an intermediate bracket attachment 34 disposed on the rail 22 between the front bracket attachment 30 and the rear 20 bracket attachment 32. Each of the bracket attachments 30, 32, 34 has a mounting end 36 and a rail end 38. The mounting end 36 of each bracket attachment 30, 32, 34 is attached to the rail 22 using an adhesive such as glue. A seal 37 is disposed over the mounting end 36 as shown in FIG. 2. FIG. 2 illustrates the front bracket attachment 30, however, the front and rear bracket attachments 30, 32 are substantial mirror images of one another.

The mounting end 36 of each bracket attachment 30, 32, 34 includes a plurality of ramp-like barbs 39, or spikes or angled flanges, that extend across a portion of the mounting end 36 and integrally with and transversely to the bracket attachment 30, 32, 34 for retaining the bracket attachment 30, 32, 34 relative to the rail 22 as shown in FIGS. 2 and 2a. The barbs 39 are angled axially toward the rail end 38 away from the rail 22, such that the rail 22 can easily slide over the barbs 39 when inserting the bracket attachment 30, 32, 34 into the rail 22, yet cannot be easily be removed once the rail 22 has been moved over the barbs 39, i.e., once the bracket attachment 30, 32, 34 has been secured to the rail 22.

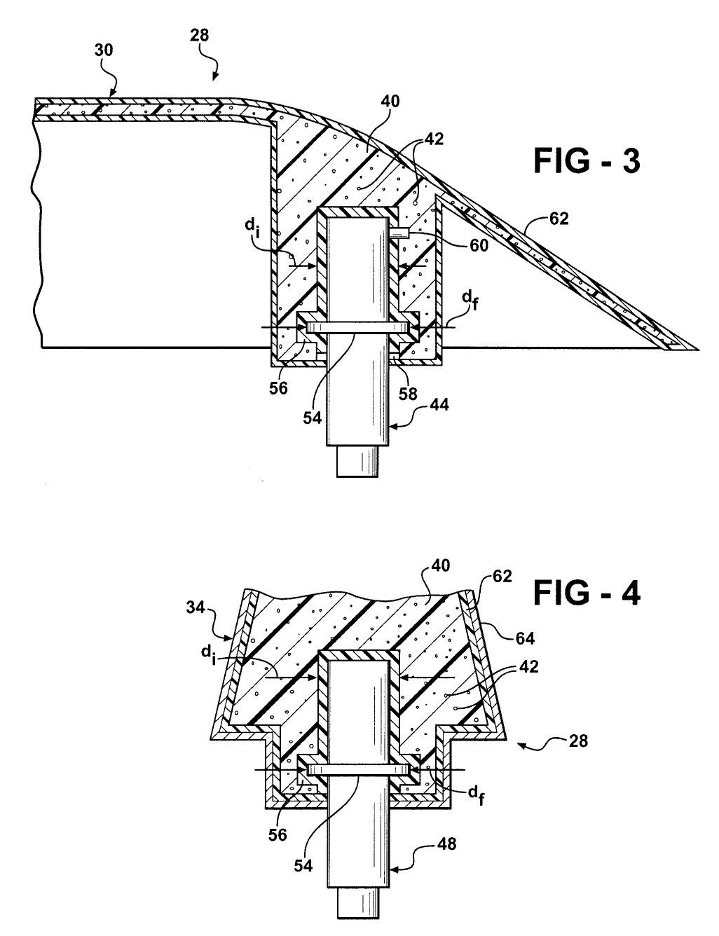

Each bracket attachment 28 is defined by a structural layer of material 40. The structural layer 40 defines a plurality of small voids 42, cavities, or pores, as shown in FIGS. 3 and 4. The voids 42 may be formed using a blowing agent such as compressed carbon dioxide or nitrogen. The voids 42 may also be formed by injecting gas into the structural layer of material 40. However, any known blowing agent or other method may be used to form the voids 42. As the structural layer 40 cools, the portion closest to the outer surface cools quickly while the interior of the structure cools more, i.e., differential cooling, which can result in sink marks and warping. The voids 42 aid in reducing the warping effect because the gas pushes the structural layer 40 back out as the structural layer 40 cools. In other words, the voids 42 provide enough local pressure to counter the inward movement as the structural layer 40 cools.

The structural layer 40 has high strength and stiffness, low warpage, good chemical resistance, and good surface finish. The structure layer is preferably a semi-crystalline partially-aromatic polyamide including 55% glass fibers by weight, i.e., 55% glass fiber reinforced, but may also be other known materials. The structural layer 40 may be the product sold under the trademark Grivory® GV-5H or Leona 90G55.

A fastener 44, 46, 48 extends along an axis A and has a supported end 50 and a distal end 52 wherein the supported end 50 is disposed in one of the bracket attachments 28 and the distal end 52 is for securing the assembly 20 to the roof of the vehicle. The structural layer 40 defining the bracket attachment 28 is therefore disposed about the fastener 44, 46, 48. The fastener 44, 46, 48 includes a front fastener 44, a rear fastener 46, and an intermediate fastener 48.

The front fastener 44 is disposed on the mounting end 36 of the front bracket attachment 30, the rear fastener 46 is disposed on the mounting end 36 of the rear bracket attachment 32, and the intermediate fastener 48 is disposed on the mounting end 36 of the intermediate bracket attachment 34 for securing the assembly 20 to the roof of the vehicle. The fasteners 44, 46, 48 may be any conventional fastener used to secure an object to a vehicle.

A flange 54 is disposed along each of the axes A and about each of the respective fasteners 44, 46, 48 for restricting axial movement of the fastener 44, 46, 48 relative to the bracket attachment 28. The cross section of the flange 54 is rectangular but may be square, circular, triangular, etc. The flange 54 is circular and has an outer flange diameter d_{f}.

An insulating layer of material 56 is disposed about each of the supported ends 50 of the fasteners 44, 46, 48 for absorbing force applied to the fastener 44, 46, 48 and the structural layer 40 is disposed about the insulating layer 56. The insulating layer of material 56 extends axially over the flange 54 of each of the fasteners 44, 46, 48 to retain the flange 54 and attached fastener 44, 46, 48 within the structural layer 40. The insulating layer 56 has elastic properties to absorb force thus reducing the risk of plastic deformation of the bracket attachment 28.

The insulating layer 56 is also corrosion resistant and has cold temperature flexibility. The insulating layer 56 may be a homogeneous compressible or flexible material such as thermoset elastomer, thermoplastic elastomer, rubber, or other known materials. Preferably a thermoplastic-polyurethane including 30% glass, i.e., 30% glass-reinforced.

The insulating layer 56 has an outer insulating diameter dᵢ which is measured along the axis A of the fastener 44, 46, 48 at a location where the flange 54 is not located. The outer insulating diameter dᵢ is smaller than the outer flange diameter d_{f}, as shown in FIGS. 3 and 4. The difference in diameters further prevents the flange 54, and thus the attached fastener 44, 46, 48, from slipping axially away from, or out of, the structural layer 40. For example, the outer flange diameter d_{f} may be 11.5 mm while the outer insulating diameter dᵢ may be 10 mm.

A torque limiter 58 is disposed about each of the fasteners 44, 46, 48 for disconnecting the fastener 44, 46, 48 from the vehicle roof to avoid excessive loading on the fastener 44, 46, 48, further reducing the risk of plastic deformation and cracking of the bracket attachment 28. Preferably, the torque limiter 58 is disposed at a location along the axis A of each fastener 44, 46, 48 where the insulating layer 56 terminates, as shown in FIG. 3, adjacent the distal end 52 of the fastener 44, 46, 48.

A plurality of ribs 60 extend radially outwardly from each of the axes A of the fasteners 44, 46, 48 through the insulating layer of material 56 and into the structural layer of material 40 for restricting rotational movement of the fastener 44, 46, 48 relative to the bracket attachment 28. The ribs 60 are disposed axially along the fastener 44, 46, 48 between the supported end 50 of the fastener 44, 46, 48 and the flange 54.

A surface layer of material 62 is disposed about the structural layer of material 40 of each of the bracket attachments 28 for providing a smooth outer surface. Specifically, the material must provide a class A surface. The surface layer 62 may be polyamide (PA)/polystyrene (PS)/PPE composite, or a PA/PPE composite but may be other known materials which provide a class A surface. For example, the surface layer can be the product sold under the trademark Xyron AT610. Preferably, the thickness of the surface layer 62 is constant and is about 2.5 mm to provide a smooth outer surface.

A final layer of material 64 is disposed about the surface layer of material 62 and about the rail 22 for providing color to the assembly 20. The final layer of material 64 is any color or type of paint and has a uniform thickness.

Obviously, many modifications and variations of the present invention are possible in light of the above teachings and may be practiced otherwise than as specifically described while within the scope of the appended claims. That which is prior art in the claims precedes the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims. In addition, the reference numerals in the claims are merely for convenience and are not to be read in any way as limiting.

What is claimed is:

1. A roof railing assembly (20) for a vehicle roof of a vehicle comprising;
a rail (22) having a front end (24) and a rear end (26),
a bracket attachment (28) disposed on said rail (22) for supporting said rail (22) on the vehicle roof,
a fastener (44, 46, 48) extending along an axis (A) and disposed on said bracket attachment (28) for securing said assembly (20) to the roof of the vehicle,
said bracket attachment (28) being defined by a structural layer of material (40) disposed about said fastener (44, 46, 48), and
characterized by a surface layer of material (62) disposed about said structural layer of material (40) of said bracket attachment (28) for providing a smooth outer surface.

2. A roof railing assembly (20) for a vehicle roof of a vehicle as set forth in claim 1 wherein said structural layer (40) defines a plurality of small voids (42).

3. An assembly (20) as set forth in claim 2 further comprising a torque limiter (58) disposed about each of said fasteners (44, 46, 48) for disconnecting said fastener (44, 46, 48) from the vehicle roof to avoid excessive loading on said fastener (44, 46, 48).

4. An assembly (20) as set forth in claim 2 further comprising at least one barb (39) extending integrally with and transversely to said bracket attachment (28) for retaining said bracket attachment (28) relative to said rail (22).

5. An assembly (20) as set forth in claim 2 further comprising a flange (54) disposed along said axis (A) and about said fastener (44, 46, 48) for restricting axial movement of said fastener (44, 46, 48) relative to said bracket attachment (28).

6. An assembly (20) as set forth in claim 5 wherein said fastener (44, 46, 48) extends along an axis (A) between a supported end (50) disposed in said bracket attachments (28) and a distal end (52) for attachment to the vehicle roof of the vehicle.

7. An assembly (20) as set forth in claim 6 further comprising an insulating layer of material (56) disposed about said supported ends (50) of said fastener (44, 46, 48) for absorbing force applied to said fastener (44, 46, 48).

8. An assembly (20) as set forth in claim 7 wherein said insulating layer of material (56) extends axially over said flange (54) of each of said fasteners (44, 46, 48).

9. An assembly (20) as set forth in claim 8 wherein said flange (54) has an outer flange diameter (d_{f}) and said insulating layer of material (56) has an outer insulating diameter (dᵢ) and wherein said outer flange diameter (d_{f}) is greater than said outer insulating diameter (dᵢ).

10. An assembly (20) as set forth in claim 8 further comprising a plurality of ribs (60) extending radially outwardly from said axis (A) of said fastener (44, 46, 48) and into said insulating layer of material (56) and disposed axially between said supported end (50) of said fastener (44, 46, 48) and said flange (54) for restricting rotational movement of said fastener (44, 46, 48) relative to said bracket attachment (28).

11. An assembly (20) as set forth in claim 7 wherein said insulating layer (56) is a thermoplastic-polyurethane including 30% glass.

12. An assembly (20) as set forth in claim 6 further comprising a plurality of ribs (60) extending radially outwardly from said axis (A) of said fastener (44, 46, 48) and into said structural layer of material (40) and disposed axially along said fastener (44, 46, 48) for restricting rotational movement of said fastener (44, 46, 48) relative to said bracket attachment (28).

13. An assembly (20) as set forth in claim 2 wherein said structural layer (40) is a semi-crystalline partially-aromatic polyamide including 55% glass fibers.

14. An assembly (20) as set forth in claim 2 wherein said surface layer (62) is a composite of polyamide and polystyrene and polyphenylene.

15. An assembly (20) as set forth in claim 2 wherein said bracket attachment (28) includes a front bracket attachment (30) disposed on said rail (22) and a rear bracket attachment (32) disposed on said rail (22) and an intermediate bracket attachment (34) disposed on said rail (22) between said front bracket attachment (30) and said rear bracket attachment (32) for supporting said rail (22) on the vehicle roof.

16. An assembly (20) as set forth in claim 15 wherein each of said bracket attachments (28) has a mounting end (36) and a rail end (38).

17. An assembly (20) as set forth in claim 16 wherein said fastener (44, 46, 48) includes a front fastener (44) and a rear fastener (46) and an intermediate fastener (48).

18. An assembly (20) as set forth in claim 17 wherein said front fastener (44) is disposed on said mounting end (36) of said front bracket attachment (30) and said rear fastener (46) is disposed on said mounting end (36) of said rear bracket attachment (32) and said intermediate fastener (48) is disposed on said mounting end (36) of said intermediate bracket attachment (34) for securing said assembly (20) to the roof of the vehicle.

19. An assembly (20) as set forth in claim 2 further comprising a final layer of material (64) disposed about said surface layer of material (62) and about said rail (22) for providing color to said assembly (20).

20. A roof railing assembly (20) for a vehicle roof of a vehicle comprising;
a rail (22) having a front end (24) and a rear end (26),
a front bracket attachment (30) disposed on said rail (22) for supporting said rail (22) on the vehicle roof,
a rear bracket attachment (32) disposed on said rail (22) for supporting said rail (22) on the vehicle roof,
an intermediate bracket attachment (34) disposed on said rail (22) between said front bracket attachment (30) and said rear bracket attachment (32) for supporting said rail (22) on the vehicle roof,
each of said bracket attachments (28) having a mounting end (36) and a rail end (38) disposed on said rail (22),
a front fastener (44) disposed on said mounting end (36) of said front bracket attachment (30) for securing said assembly (20) to the roof of the vehicle,
a rear fastener (46) disposed on said mounting end (36) of said rear bracket attachment (32) for securing said assembly (20) to the roof of the vehicle,
an intermediate fastener (48) disposed on said mounting end (36) of said intermediate bracket attachment (34) for securing said assembly (20) to the roof of the vehicle,
each of said fasteners (44, 46, 48) extending along an axis (A) between a supported end (50) disposed in one of said brackets and a distal end (52),
an insulating layer of material (56) having an outer insulating diameter (dᵢ) and disposed about each of said supported ends (50) of said fasteners (44, 46, 48) for absorbing force applied to said fastener (44, 46, 48),
a flange (54) having an outer flange diameter (d_{f}) and disposed along said axis (A) and about each of said fasteners (44, 46, 48) for restricting axial movement of said fastener (44, 46, 48) relative to said bracket attachment (28),
each of said bracket attachments (28) being defined by a structural layer of material (40) disposed about said fastener (44, 46, 48) and about said insulating layer of material (56),
a final layer of material (64) disposed about said surface layer of material (62) and about said rail (22) for providing color to said assembly (20),
characterized by
a surface layer of material (62) disposed about said structural layer of material (40) of each of said bracket attachments (28) for providing a smooth outer surface,
said surface layer (62) being a composite of polyamide and polystyrene and polyphenylene,
said structural layer (40) defining a plurality of small voids (42),
said structural layer (40) being a semi-crystalline partially-aromatic polyamide including 55% glass fibers,
said insulating layer of material (56) extending axially over said flange (54) of each of said fasteners (44, 46, 48),
said insulating layer (56) being a thermoplastic-polyurethane including 30% glass,
said outer flange diameter (d_{f}) being greater than said outer insulating diameter (dᵢ),
a torque limiter (58) disposed about each of said fasteners (44, 46, 48) for disconnecting said fastener (44, 46, 48) from the vehicle roof to avoid excessive loading on said fastener (44, 46, 48), and
a plurality of ribs (60) extending radially outwardly from each of said axes (A) of said fasteners (44, 46, 48) and into said structural layer of material (40) and disposed axially between said supported end (50) and said respective flange (54) of each fastener (44, 46, 48) for restricting rotational movement of said fastener (44, 46, 48) relative to said bracket attachment (28).

21. A roof railing assembly (20) for a vehicle roof of a vehicle comprising;
a rail (22) having a front end (24) and a rear end (26),
a bracket attachment (28) disposed on said rail (22) for supporting said rail (22) on the vehicle roof,
a fastener (44, 46, 48) extending along an axis (A) and disposed on said bracket attachment (28) for securing said assembly (20) to the roof of the vehicle, and
characterized by a torque limiter (58) disposed about said fastener (44, 46, 48) for disconnecting said fastener (44, 46, 48) from the vehicle roof to avoid excessive loading on said fastener (44, 46, 48).

22. A roof railing assembly (20) for a vehicle roof of a vehicle comprising prior;
a rail (22) having a front end (24) and a rear end (26),
a bracket attachment (28) disposed on said rail (22) for supporting said rail (22) on the vehicle roof,
a fastener (44, 46, 48) extending along an axis (A) and disposed on said bracket attachment (28) for securing said assembly (20) to the roof of the vehicle, and
characterized by a plurality of ribs (60) disposed on said fastener (44, 46, 48) and extending radially outwardly from said axis (A) of said fastener (44, 46, 48) and into said bracket attachment (28) for restricting rotational movement of said fastener (44, 46, 48) relative to said bracket attachment (28).
